(19) United States
(12) Patent Application Publication
(10) Pub. No.: US 2010/0046620 A1
(43) Pub. Date: Feb. 25, 2010

(54) SCALABLE VIDEO CODING ENCODER WITH ADAPTIVE REFERENCE FGS AND FGS MOTION REFINEMENT MECHANISM AND METHOD THEREOF

(76) Inventors: Jung-Won Kang, Seoul (KR); Hae-Chul Choi, Daejeon-city (KR); Jae-Gon Kim, Daejeon-city (KR); Jin-Woo Hong, Daejeon-city (KR); Yong-Man Ro, Daejeon-city (KR); Troung Cong Thang, Daejeon-city (KR); Tae-Moon Bae, Daegu-city (KR)

Correspondence Address: LADAS & PARRY LLP, 224 SOUTH MICHIGAN AVENUE, SUITE 1600, CHICAGO, IL, 60604, US

(21) Appl. No.: 12/445,091

(22) PCT Filed: Oct. 16, 2007
(86) PCT No.: PCT/KR2007/005065

§ 371 Date: Apr. 10, 2009

(30) Foreign Application Priority Data
Jan. 9, 2007 (KR) 10-2007-0002653
Oct. 16, 2007 (KR) 10-2007-0104240

(51) Int. Cl. H04N 7/26

(52) U.S. Cl. 375/240.12; 375/E07.078

(57) ABSTRACT

Provided are alternatives for improving coding efficiency when an AR-FGS technique and an FGS motion refinement technique are applied to scalable video coding. When prediction of a residual signal an FGS layer is not performed, a ′ prediction signal of block related to the FGS layer is predicted in the same manner as the manner of predicting a prediction signal of a base quality layer. A scaling factor is allowed to have a non-zero value if required, and the residual signal of the FGS layer is used to determine a scaling factor of a higher FGS layer. The AR-FGS and FGS motion refinement techniques are restricted from being simultaneously used for key pictures.

### TECHNICAL FIELD

The present invention relates to scalable video coding (SVC) employing a fine grain SNR scalability (FGS) motion refinement technique and an adaptive reference (AR) FGS technique.

### BACKGROUND ART

In scalable video coding (SVC), FGS is an important feature to finely control video quality in SNR dimension. When an FGS layer is removed, picture quality degradation can be propagated to a subsequent picture due to the inter-frame prediction structure of an SVC video signal.

The picture quality degradation propagation can be controlled by an adaptive reference (AR) FGS technique for improving coding efficiency. Furthermore, an FGS motion refinement technique for setting a motion vector in each FGS layer can be used to improve coding efficiency of FGS layers. However, when the AR FGS and FGS motion refinement techniques are used together, the AR FGS technique is not working appropriately because a residual signal of an FGS layer block is not predicted from a base layer (i.e. a base quality layer or a lower FGS layer) block corresponding to the FGS layer block according to the FGS motion refinement technique.

This work was supported by the IT R&D program of MIC (Ministry of Information and Communication)/IITA (Institute for Information Technology Advancement) [2005-S-103-02, “Development of Ubiquitous Content Access Technology for Convergence of Broadcasting and Communications”].

### BRIEF DESCRIPTION OF THE DRAWINGS

FIG. 1 illustrates an AR-FGS structure of conventional SVC;

FIG. 2 illustrates an AR-FGS structure in SVC according to a preferred embodiment of the present invention;

FIGS. 3A through 3E illustrate a decoding process in a standardization document with respect to a first alternative described with reference to FIG. 2 according to an embodiment of the present invention;

FIGS. 4A and 4B illustrate a decoding process in a standardization document for a second alternative described with reference to FIG. 2 according to an embodiment of the present invention;

FIG. 5 illustrates syntax for a third alternative according to a preferred embodiment of the present invention;

FIG. 6 illustrates a decoding process in a standardization document for the third alternative according to an embodiment of the present invention;

FIG. 7 illustrates syntax for a fourth alternative according to an embodiment of the present invention;

FIG. 8 illustrates syntax for a fifth alternative according to an embodiment of the present invention;

FIG. 9 illustrates syntax for a sixth alternative according to an embodiment of the present invention;

FIG. 10 is a block diagram of an SVC encoder employing improved AR-FGS and FGS motion refinement techniques according to an embodiment of the present invention;

FIG. 11 is a flow chart illustrating the operation of the SVC encoder illustrated in FIG. 10, according to an embodiment of the present invention;

FIG. 12 is a block diagram of an SVC encoder employing improved AR-FGS and FGS motion refinement techniques corresponding to the third alternative according to an embodiment of the present invention; and

FIG. 13 is a block diagram of an SVC encoder employing improved AR-FGS and FGS motion refinement techniques corresponding to the fourth, fifth, and sixth alternatives according to another embodiment of the present invention.

### TECHNICAL PROBLEM

The FGS motion refinement technique in SVC can be used to improve coding efficiency of FGS layers. The FGS motion refinement technique allows the FGS layers to have motion information and a block mode different from that of a base quality layer.

In this case, a residual signal of an FGS layer block may not be predicted from the co-located block in its base layer and a residual signal of a base quality layer is not suitable to control adaptability of AR-FGS. Furthermore, current AR-FGS considers only the property of the residual signal of the base quality layer, and thus a problem may be generated when the AR-FGS technique and the FGS motion refinement technique are simultaneously used.

Accordingly, the present invention provides alternatives for solving problems that may occur when the AR-FGS and FSG motion refinement techniques are simultaneously applied, thereby improving adaptability of AR-FGS.

### TECHNICAL SOLUTION

According to an aspect of the present invention, there are provided alternatives capable of improving coding efficiency when the AR-FGS and FGS motion refinement techniques are simultaneously applied to SVC.

When a residual signal of a block in an FGS layer is not predicted, a prediction signal of the block in the FGS layer is predicted in the same manner as predicting a prediction signal of a base quality layer.

A scaling factor can have a non-zero value if required, and a residual signal of an FGS block for which residual signal prediction is not performed is used to determine a scaling factor of a higher FGS layer.

When interlayer residual signal prediction is always activated, an adaptation process is determined based on the residual signal of the base quality layer.

The FGS and FGS motion refinement techniques are not simultaneously used for key pictures.

According to an aspect of the present invention, there is provided an SVC encoder using improved AR-FGS and FGS motion refinement techniques, comprising: a prediction signal determination unit determining a prediction signal of a current FGS layer block according to a scaling factor of a current FGS layer when interlayer prediction is not performed between a base quality layer or a lower FGS layer and the current FGS layer; and a scaling factor determination unit determining a scaling factor used to predict a higher FGS layer block corresponding to the current FGS layer block based on a residual signal of the current FGS layer block.

According to another aspect of the present invention, there is provided an SVC encoder using improved AR-FGS and FGS motion refinement techniques, comprising: an interlayer prediction setting unit setting that interlayer prediction is inevitably performed between a base layer (i.e. a base quality layer or a lower FGS layer) and each FGS layer; and a scaling factor determination unit determining a scaling factor of a higher FGS layer based on a residual signal of the base layer.

According to another aspect of the present invention, there is provided an SVC encoder using improved AR-FGS and FGS motion refinement techniques, comprising an FGS-MR inactivation unit preventing the FGS motion refinement technique from being applied to a key picture when a picture in a GOP of an input bit stream corresponds to the key picture.

According to another aspect of the present invention, there is provided an SVC encoder using improved AR-FGS and FGS motion refinement techniques, comprising a selective FGS-MR inactivation unit preventing the FGS motion refinement technique from being applied to a key picture only when the AR-FGS technique is [A1]applied to the key picture in the case where a picture in a GOP of an input bit stream corresponds to the key picture.

According to another aspect of the present invention, there is provided an SVC encoder using improved AR-FGS and FGS motion refinement techniques, comprising an FGS-MR inactivation unit preventing the FGS motion refinement technique from being applied to a key picture and an AR-FGS inactivation unit blocking the AR-FGS technique from being applied to the key picture when a picture in a GOP of an input bit stream corresponds to the key picture.

According to another aspect of the present invention, there is provided an SVC decoder using improved AR-FGS and FGS motion refinement techniques, wherein a prediction signal of a current FGS layer block is decoded according to a scaling factor of a current FGS layer when the FGS motion refinement technique is applied to the current FGS layer and interlayer prediction is not performed between the current FGS layer and a base quality layer or a lower FGS layer in an operation of decoding each FGS layer, and the scaling factor is determined by an SVC decoder based on a residual signal of the current FGS layer block.

According to another aspect of the present invention, there is provided an SVC decoder using improved AR-FGS and FGS motion refinement techniques, wherein the SVC decoder inevitably determines a scaling factor of a higher FGS layer based on a residual signal of a base layer when a received bitstream is configured such that interlayer prediction is inevitably performed between the base layer and each FGS layer.

According to another aspect of the present invention, there is provided an SVC decoder using improved AR-FGS and FGS motion refinement techniques, wherein the SVC decoder does not check a flag that represents that the FGS motion refinement technique is applied to a key picture of a GOP in a received bit stream.

According to another aspect of the present invention, there is provided an SVC decoder using an improved AR-FGS technique, wherein the SVC decoder determines a scaling factor used to predict a higher FGS layer block corresponding to a current FGS layer block based on a residual signal of a current FGS layer block when receiving a bit stream including an interlayer prediction setting signal that represents that interlayer prediction is set to be performed between a base layer and each FGS layer.

According to another aspect of the present invention, there is provided an SVC decoding method using improved AR-FGS and FGS motion refinement techniques, the SVC decoding method comprising: determining whether a current frame corresponds to a key picture; and determining whether the AR-FGS technique is applied when the current frame corresponds to the key picture and determining whether the FGS motion refinement technique is applied when the current frame does not correspond to the key picture.

### ADVANTAGEOUS EFFECTS

The present invention improves coding efficiency when AR-FGS and FGS motion refinement are simultaneously applied to SVC. Furthermore, the present invention can solve problems generated when the AR-FGS and the FGS motion refinement are simultaneously used because adaptation of current AR-FGS considers only the property of the residual signal of the base layer.

### MODE OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. Throughout the drawings, like reference numerals refer to like elements.

SVC is an important technique for video communication in a heterogeneous environment. The SVC technology allows, under constraints of a terminal or networks, truncation of original video bitstream to provide output bitstreams corresponding to different presentations of the original content. The scalability of SVC video is supported in three dimensions, namely spatial, temporal, and SNR.

In SVC, FGS can finely control video quality. For each spatial resolution, a base quality layer is first encoded by a method similar to H.264/AVC. Then, up to three FGS layers can be added to the base quality layer in order to enhance the SNR quality of the corresponding base quality layer. These FGS layers can be extracted from an arbitrary point in order to meet a bit rate condition.

Video quality (SNR) degradation can be propagated to following pictures because of the influence of a removed FGS layer and an inter-frame prediction structure. This propagation is referred to as a drift error in SVC. To avoid the drift error, inter-frame prediction of a key picture can be obtained using only information of the base quality layer of a previous frame. However, this solution results in low coding efficiency as the best inter-frame prediction is not used.

To provide a flexible tradeoff between coding efficiency and error robustness, the AR-FGS has been suggested. The AR-FGS technique adaptively controls a portion of FGS information which is used to compose the inter-frame prediction based on the characteristics of base quality layer.

Furthermore, the FGS motion refinement technique also increases coding efficiency of FGS layers. The FGS motion refinement technique allows each FGS layer to have a motion vector such that a block mode is different from the base quality layer.

However, because of the property that a residual signal of an FGS layer block may not be predicted from the co-located block in its base layer, there may be a problem to control adaptability of AR-FGS that considers only the property of a residual signal of the base quality layer.

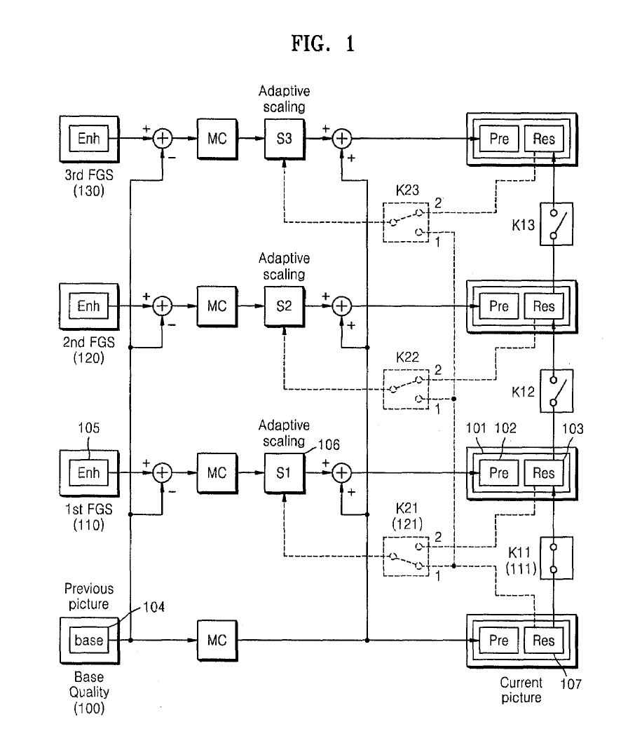

Problems generated when the FGS motion refinement technique and the AR-FGS technique are simultaneously used in conventional SVC are described with reference to FIG. 1.

FIG. 1 illustrates an AR-FGS structure of conventional SVC. Referring to FIG. 1, a spatial resolution consists one base quality layer 100 and first to third additional FGS layers 110, 120, and 130. Processing of the first FGS layer 110 is explained as an example.

A reconstructed signal of a block 101 includes a prediction signal 102 and a residual signal 103. The prediction signal 102 corresponds to the sum of a prediction signal that is motion-compensated from a reconstructed signal 104 of a previous picture block of the base quality layer and a predicted signal that is motion-compensated from a difference between a reconstructed signal 105 of the first FGS layer 110 and the reconstructed signal 104 of the previous picture.

The predicted signal that is motion-compensated from the difference between the reconstructed signal 105 of the first FGS layer 110 and the reconstructed signal 104 of the previous picture is multiplied by a first scaling factor S1 in an adaptive scaling unit 106. When the first scaling factor S1 is 0, the prediction signal 102 is obtained only from the base quality layer and video quality degradation does not occur even when FGS information is extracted from the block 105 of the first FGS layer 110. When the first scaling factor S1 is not zero, however, the prediction signal 102 will have better video quality if FGS information is not extracted from the block 105 of the first FGS layer 110. Two cases in which the first scaling factor S1 is controlled are explained below.
When a switch K11 is closed

Firstly, inter-layer prediction from the base quality layer (or a lower FGS layer) to a higher FGS layer is considered. When the switch K11 (111) is connected to the first FGS layer 110 and thus prediction occurs from the base layer 100 to a higher FGS layer, the first scaling factor S1 is determined based on the coefficient of a residual signal 107 of the base quality layer 100. When the coefficient of the residual signal 107 is not 0 (when a switch K21 (121) is switched to a node 1), a corresponding coefficient of the prediction signal 102 is obtained by setting the first scaling factor S1 to 0. When the coefficient of the residual signal 107 is 0, the corresponding coefficient of the prediction signal 102 is determined by setting the first scaling factor S1 to a non-zero value. The non-zero value of the first scaling factor S1 depends on contents and application programs.

When all the coefficients of the residual signal 107 are 0, scaling occurs in a spatial domain. When any coefficient of the residual signal 107 is non-zero, scaling is performed in a transform domain. That is, a differentiate signal is converted from the spatial domain to the transform domain and then scaled.
When the switch K1 is opened

The second case that there is not inter-layer prediction from the base quality layer (or a lower FGS layer) to a higher FGS layer is considered. For example, when the switch K11 (111) is not connected to the first FGS layer 110, and thus prediction from the base quality layer 100 to a higher FGS layer is not carried out, the first scaling factor S1 is determined by the same method as in the first case except that the switch K21 (121) is switched to a node 2 and the first scaling factor S1 is set based on coefficients of the residual signal 103 of the first FGS layer 110. Accordingly, a problem that the residual signal 103 of the current FGS layer is used to determine the scaling factor S1 is generated.

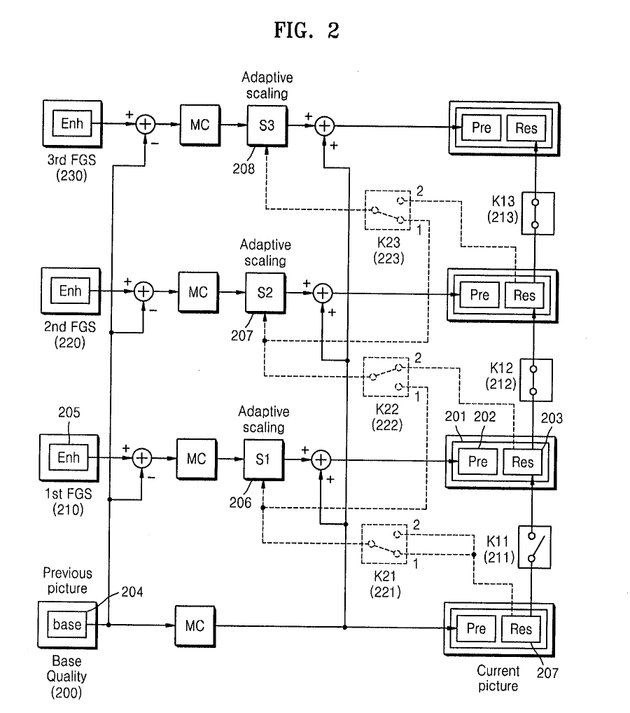

Alternatives proposed in the present invention in order to solve problems generated when the AR-FGS technique and the FGS motion refinement technique are used together will now be described with reference to FIG. 2.

FIG. 2 illustrates an AR-FGS structure in SVC according to a preferred embodiment of the present invention. Referring to FIG. 2, connection switches K11, K12 and K13 are controlled according to the FGS motion refinement technique. As described above with reference to FIG. 1, when interlayer prediction is generated between residual blocks 103 and 107, simultaneously application of the AR-FGS technique and the FGS motion refinement technique does not become a problem. However, when there is no interlayer prediction, a problem is generated when the scaling factor Si is determined. Alternatives for solving this problem are explained below with reference to FIG. 2.

### First Alternative

When a connection switch K1i is opened and thus an interlayer residual signal prediction is not performed, a scaling factor Si of an ith FGS layer is set to 0 such that a prediction signal of a related block in the ith FGS layer corresponds to a prediction signal of a base quality layer 200. For example, a prediction signal of a related block 202 in the first FGS layer 210 becomes identical to the prediction signal of the base quality layer.

When the switch K1i is opened and a switch K1ᵢ₊₁ is closed, a scaling factor S(i+1) of an (i+1)th FGS layer is determined based on a residual signal of the ith FGS layer. Additionally, When the switch K1i is opened, the switch K1ᵢ₊₁ is closed and a switch K1ᵢ₊₂ is closed, the scaling factor S(i+1) of the (i+1)th FGS layer and a scaling factor S(i+2) of an (i+2)th FGS layer are determined based on an ith residual signal. For example, when i is 1, the scaling factors S(i+1) and S(i+2) are determined based on a residual signal 203.
When the switch K11 is opened

1) The scaling factor S1 is set to 0 when residual signal prediction is inactivated between the base quality layer 200 and the first FSG layer 210. Then, the residual signal 203 of the first FGS layer 210 is obtained in the same manner as the manner of obtaining a residual layer 207 of the base quality layer 200.

For example, the prediction signal 202 of the first FGS layer 210 is identical to a prediction layer of the base quality layer 200 and the residual signal 203 of the first FGS layer 210 is encoded irrespective of the residual signal 207 of the base quality layer 200. In this case, the residual signal 203 is not encoded by using prediction but encoded by using a quantization parameter different from the quantization used to encode the residual signal 207. The residual signal 203 can be used to determine a residual signal of the second FGS layer 220 and a scaling factor S2.

2) When the switch K11 (211) is opened and the switch K12 (212) is closed, a switch K22 (222) is switched to a node 2 and the residual signal 203 of the first FGS layer 210 is used to determine the scaling factor S2 of the second FGS layer 220.

3) When the switches K12 (212) and K13 (213) are closed, a switch K23 (233) is switched to a node 1 and the scaling factors S2 and S3 are determined based on the residual signal 203.

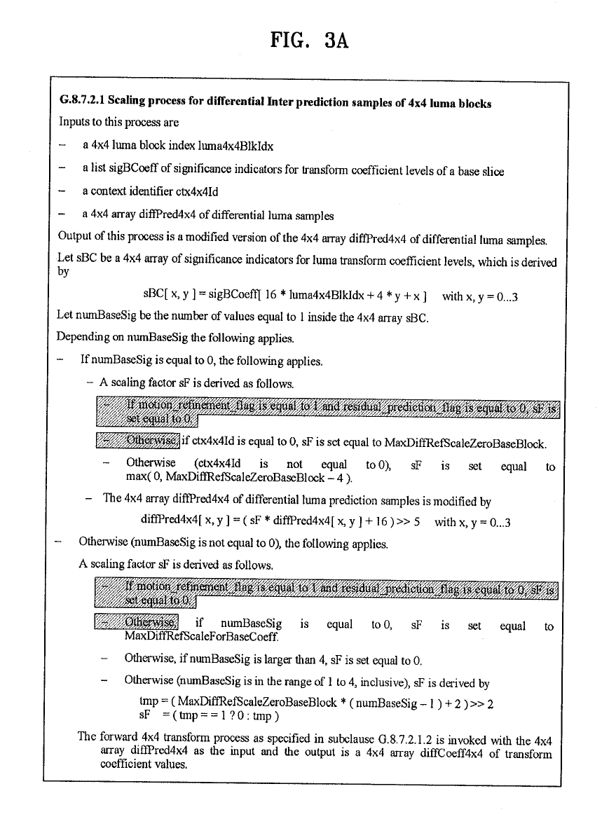

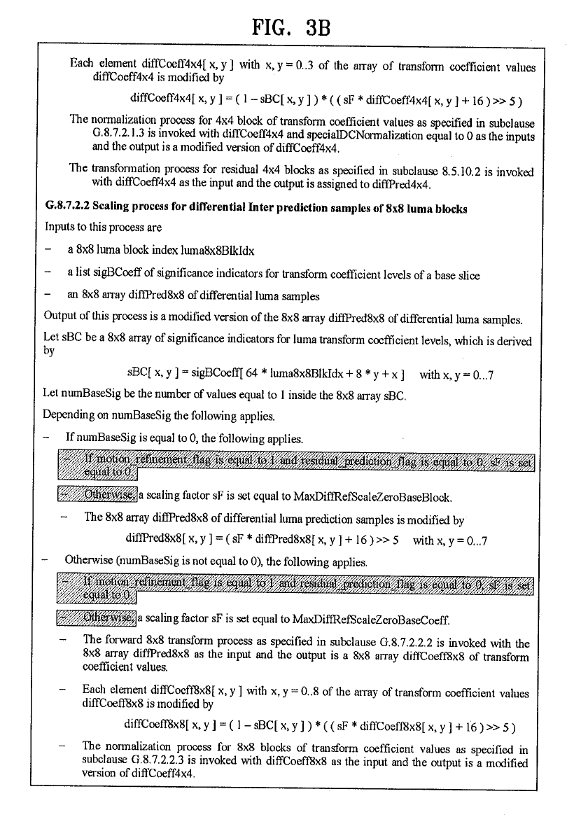

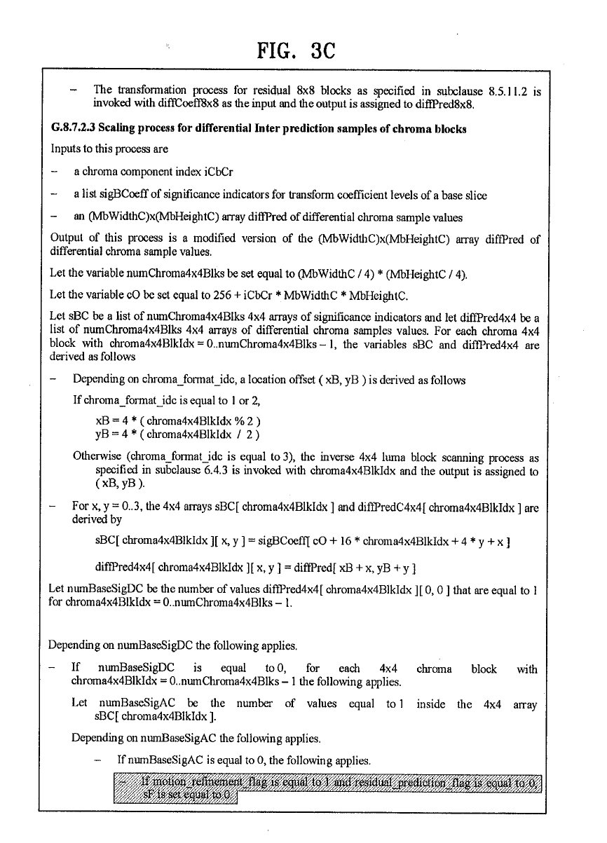

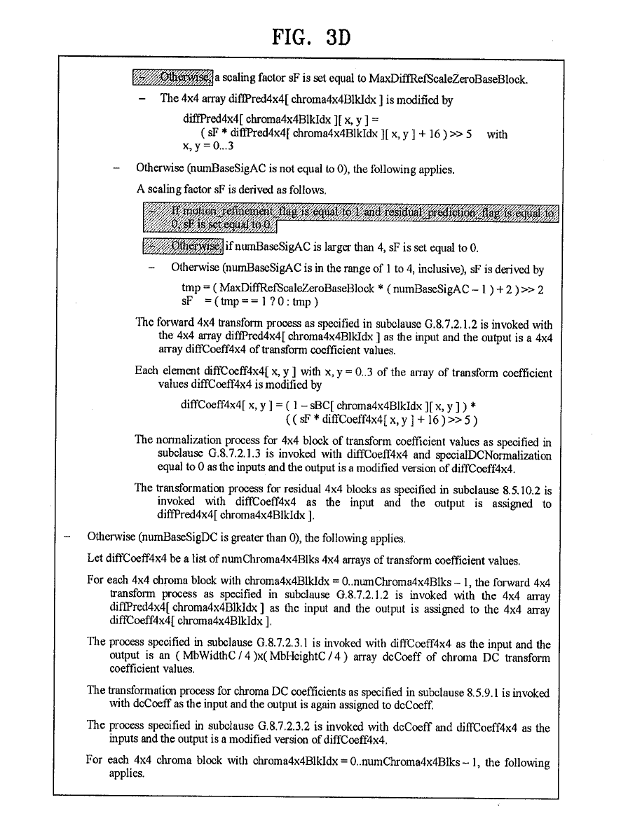

FIGS. 3A through 3E illustrate a standardization document with respect to the first alternative proposed in the present invention. Parts of the standardization document, which are modified according to the first alternative proposed in the present invention, are shaded in FIGS. 3A through 3E. In FIGS. 3A through 3E, an additional part is the syntax of setting a scaling factor sF to 0 when the FGS motion refinement is used (motion_refinement_flag=1) and residual signal prediction is not used (residual_prediction_flag=0) in a decoding process of determining scale factors when FGS layers are decoded.

### Second Alternative

In the first alternative, the scaling factor Si of the ith FGS layer is set to 0 such that a prediction signal of a related block of the ith FGS layer becomes identical to the prediction signal of the base layer when the connection switch K1i is opened and interlayer residual prediction is not performed. The second alternative is distinguished from the first alternative as to whether the scaling factor Si is set to 0 or not.

That is, in the second alternative, the scaling factor Si is set to a non-zero value if required even though there is not interlayer residual prediction because the connection switch K1i is opened, and a residual signal of an FGS block for which interlayer prediction is not performed is used to determine a scaling factor of a higher FGS layer.

For example, when the switch K11 (211) is opened and the switch K12 (212) is closed, the switch K22 (222) is switched to the node 2 and the residual signal 203 of the first FGS layer 210 is used to determine the scaling factor S2 of the second FGS layer 220.

The problem described above with reference to FIG. 1 that the block 102 is predicted from the scaling factor S1 of the first FGS layer 110 can also be solved using the second alternatives.

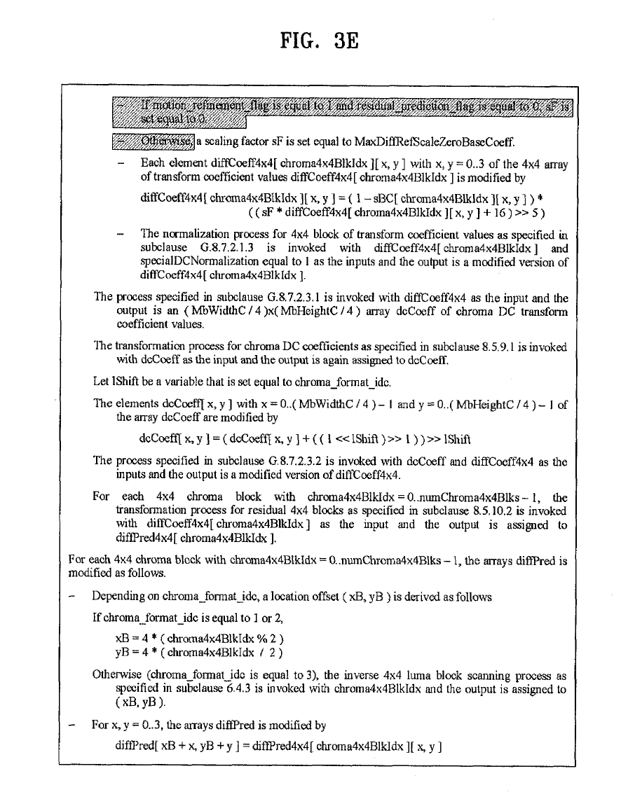

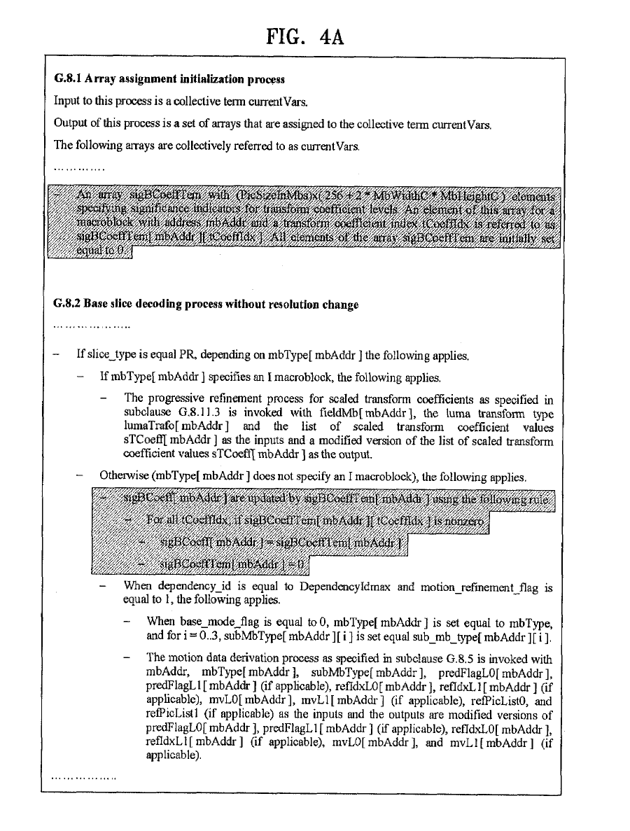

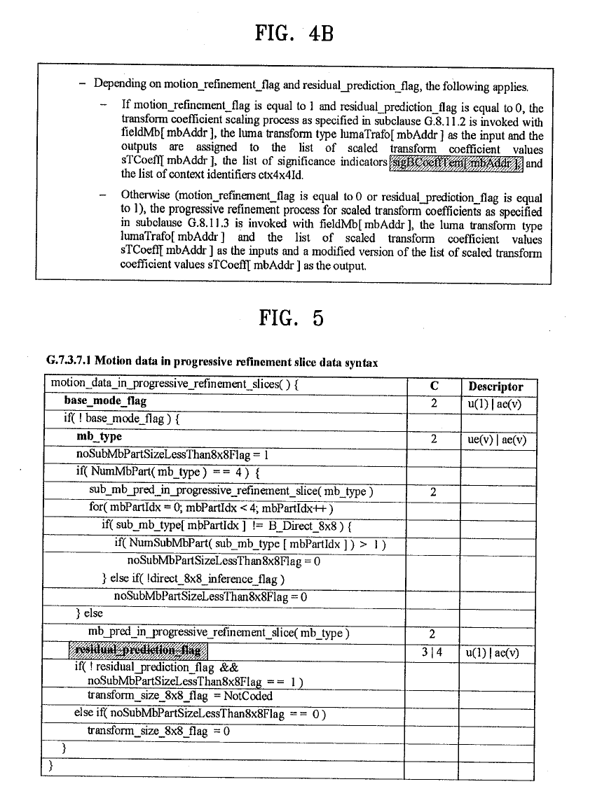

FIGS. 4A and 4B illustrate a standardization document of a decoding process for the second alternative described with reference to FIG. 2 according to an embodiment of the present invention. Parts of the standardization document, which are modified according to the second alternative proposed in the present invention, are shaded in FIGS. 4A and 4B.

In FIGS. 4A and 4B, an additional decoding process allows the scaling factor Si of the ith FGS layer to be determined by the residual signal 107 of the (i-1)th FGS layer when the switch K1i is opened, which is distinguished from the current standardization document in which the scaling factor Si of the ith FGS factor is determined by the residual signal of the ith FGS layer when the switch K1i is opened (for example, the scaling factor S1 is determined by the residual signal 103 when the switch K11 is opened).

A variable sigBCoeff represents a value corresponding to a residual signal and is used to determine a scaling factor. In the current standardization document, sigBcoeff of the ith FGS layer determines the scaling factor of the ith FGS layer when motion_refinement_flag is 1 and residual_prediction_flag is 0. That is, the residual signal 103 determines the scaling factor S1. However, in the present invention, a variable sigBCoeffTem is generated and the standardization document is modified such that sigBCoeff has the residual signal value of the (i-1)th FGS layer in order to solve problems of the current standardization document.

### Third Alternative

The third alternative is proposed for AR-FGS when the FGS motion refinement is inevitably performed between the base layer and each FGS layer. In the third alternative, the switches K11 (211), K12 (212) and K13 (213) are set to be closed always. That is, in the third alternative, interlayer prediction is activated always such that interlayer residual signal prediction is carried out. Accordingly, all the switches K21 (221), K22 (222) and K23 (223) are switched to the node 1, and thus the residual signal 207 of the base quality layer is always used to determine the scaling factor Si.

FIG. 5 illustrates syntax of the third alternative according to a preferred embodiment of the present invention. A deleted part in FIG. 5 is syntax that represents whether residual signal prediction (interlayer prediction) is accomplished or not so that residual signal prediction is performed when residual_prediction-flag is 1 and residual signal prediction is not carried out when residual_prediction-flag is 0. However, there is no need to transmit residual_prediction_flag to a decoder if it is set that residual signal prediction is performed, as described above, and thus the syntax is deleted.

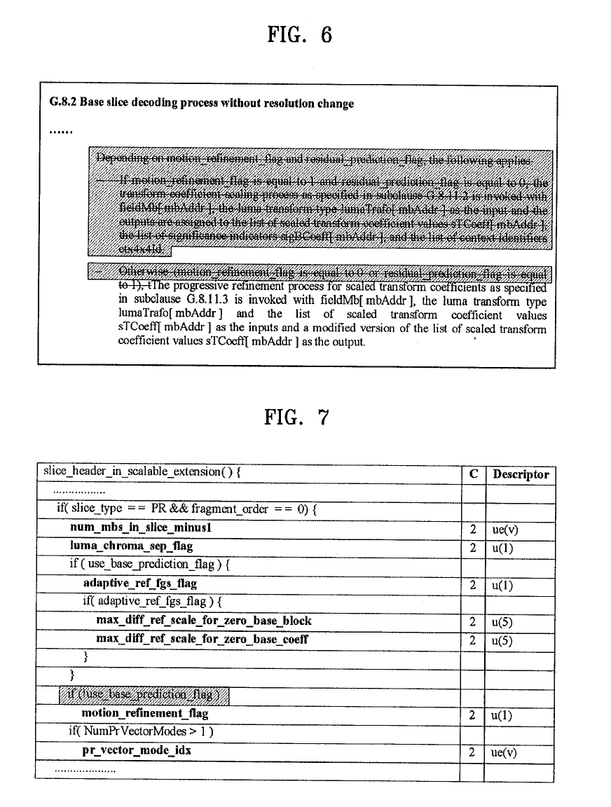

FIG. 6 illustrates a standardization document of a decoding process for the third alternative according to an embodiment of the present invention. In FIG. 6, since residual_prediction_flag is always 1 in FGS layers, descriptions related to the decoding process when residual_prediction_flag is 0 are deleted and a process of checking whether residual_prediction_flag is 1 is also deleted.

Parts of the standardization document, which are modified according to the third alternative, are shaded in FIGS. 5 and 6.

### Fourth Alternative

The AR-FGS technique is applied only to a key picture in a group of picture (GOP) in SVC. Thus, the FGS motion refinement is not applied to the key picture to solve the problem generated when the AR-FGS and FGS motion refinement are simultaneously applied. Accordingly, there is no need to modify the existing AR-FGS technique in order to receive the FGS motion refinement technique.

FIG. 7 illustrates syntax for the fourth alternative according to an embodiment of the present invention. In FIG. 7, use_base_prediction flag is a flag that represents whether a current picture corresponds to a key picture or not.

Although motion_refinement_flag that represents whether the motion refinement technique is used is checked for all pictures in the conventional standardization document, in the present invention, motion_refinement_flag is checked only for a picture that is not a key picture.

### Fifth Alternative

In the fifth alternative, the FGS motion refinement is not applied when the AR-FGS technique is used for a key picture and applies the FGS motion refinement technique when the AR-FGS technique is not used for the key picture. The fifth alternative is distinguished from the fourth alternative in that the FGS motion refinement technique is not applied to all the key pictures.

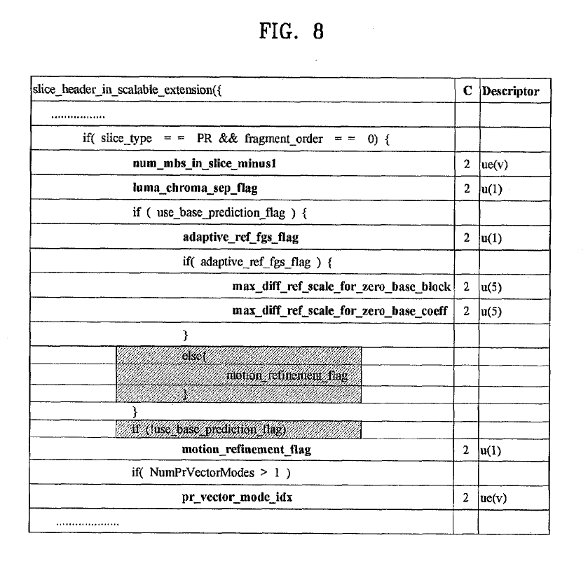

FIG. 8 illustrates syntax for the fifth alternative according to an embodiment of the present invention. Referring to FIG. 8, when the AR-FGS is not used (if adaptive_ref_fga_flag is 1, AR-FGS is used), motion_refinement_flag is used to indicate whether the motion refinement technique is applied.

### Sixth Alternative

In the sixth alternative, both the AR-FGS technique and the FGS motion refinement technique are not applied for a key picture in SVC. In this case, bit stream complexity is decreased and video quality degradation propagation is reduced although encoding efficiency of encoded video signals is not high.

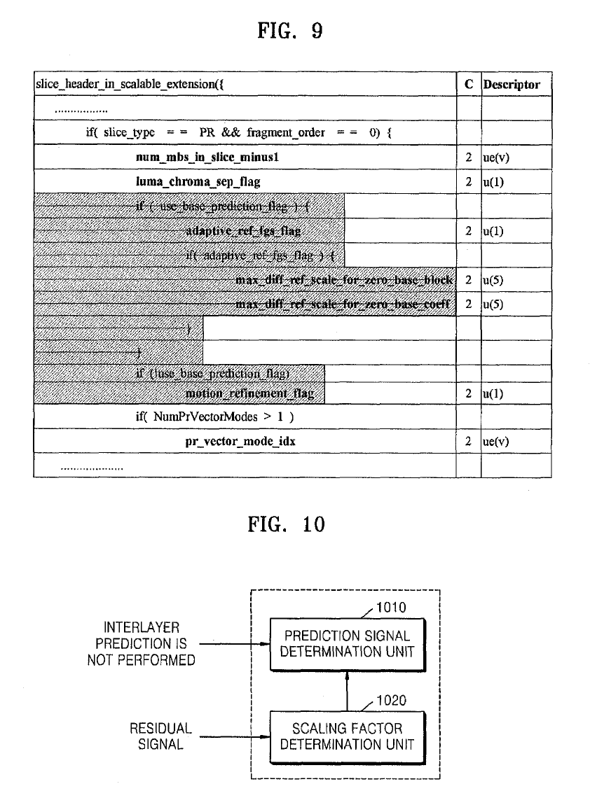

FIG. 9 illustrates syntax for the sixth alternative according to an embodiment of the present invention. Referring to FIG. 9, adaptive_ref_fgs_flag that represents whether the AR-FGS technique is used and motion_refinement_flag that represents whether the motion refinement technique is used are not used for a key picture.

### Improved AR-FGS Application Method

In addition to the first through sixth alternative, the present invention proposes an improved AR-FGS application method that determines the scaling factor Si of the ith FGS layer by using the residual signal of the (i−1)th FGS layer when interlayer prediction is used for a residual signal in AR-FGS (when the FGS motion refinement technique is not used or when interlayer prediction is used for a residual signal although the FGS motion refinement technique is used) based on the fact that the residual signal of the (i−1)th FGS layer is more similar to the residual signal of the ith FGS layer than to the residual signal of the base quality layer.

Specifically, when the switch K12 (212) is closed in FIG. 2, the residual signal 203 can be used to determine the scaling factor S2. In this case, the switch K22 (222) is switched to the node 2.

The improved AR-FGS application method can be combined with the third, fourth, and fifth alternatives. For example, when both the switches K11 (211) and K12 (212) are closed, the scaling factor S1 is determined by the residual signal 207 and the scaling factor S2 is determined by the residual signal 203.

FIG. 10 is a block diagram of an SVC encoder employing improved AR-FGS and FGS motion refinement techniques according to an embodiment of the present invention. Referring to FIG. 10, the SVC encoder includes a prediction signal determination unit 1010 and a scaling factor determination unit 1020.

The prediction signal determination unit 1010 determines a prediction signal of a current FGS layer block according to a scaling factor of a current FGS layer when interlayer prediction is not performed between the base quality layer or a lower FGS layer and the current FGS layer. The prediction signal of the current FGS layer block is determined according to the above-described first alternative when the scaling factor of the current FGS layer is 0, and the prediction signal of the current FGS layer block is determined according to the above-described second alternative when the scaling factor of the current FGS layer is not 0.

The scaling factor determination unit 1020 determines a scaling factor used to predict a higher FGS layer block corresponding to the current FGS layer block based on the residual signal of the current FGS layer block. In this case, interlayer prediction is set to be performed between the current FGS layer and the higher FGS layer. The detailed operation of the scaling factor determination unit 1020 relates to the first and second alternatives.

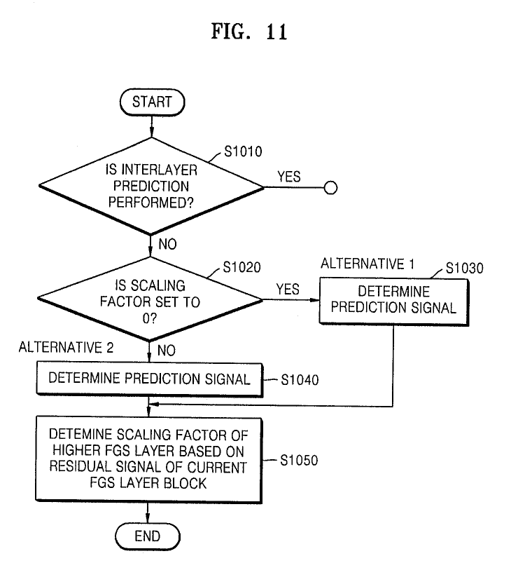

FIG. 11 is a flow chart illustrating the operation of the SVC encoder illustrated in FIG. 10. Referring to FIG. 11, it is determined whether interlayer prediction is performed between the base quality layer or a lower FGS layer and a current FGS layer in operation S1010. When it is determined that interlayer prediction is not carried out between the base quality layer or the lower FGS layer and the current FGS layer, a prediction signal is determined according to the first alternative if the scaling factor of the current FGS layer is 0 in operation S1030 and the prediction signal is determined according to the second alternative if the scaling factor of the current FGS layer is not 0 in operation S1040. Then, the scaling factor of the higher FGS layer is determined on the basis of the residual signal of the current FGS layer block in operation S1050.

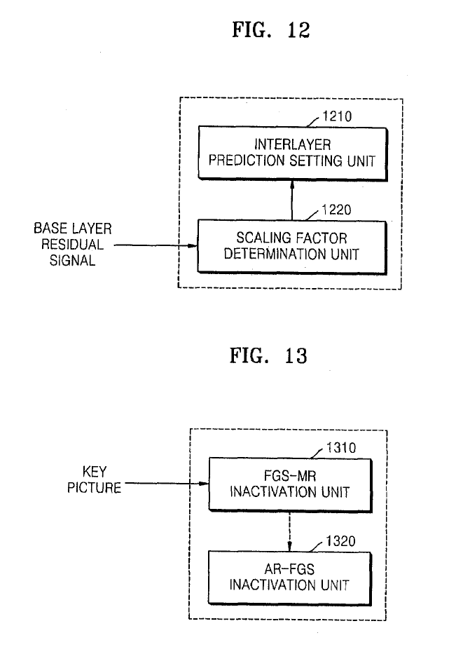

FIG. 12 is a block diagram of an SVC encoder employing the improved AR-FGS and FGS motion refinement techniques corresponding to the third alternative according to an embodiment of the present invention. Referring to FIG. 12, the SVC encoder includes an interlayer prediction setting unit 1210 and a scaling factor determination unit 1220.

The interlayer prediction setting unit 1210 sets that interlayer prediction is inevitably performed between the base layer and each FGS layer. The scaling factor determination unit 1220 determines a scaling factor of a higher FGS layer based on the residual signal of the base layer always. The operation of the SVC encoder illustrated in FIG. 12 is described in more detail in the third alternative.

FIG. 13 is a block diagram of an SVC encoder employing the improved AR-FGS and FGS motion refinement technique corresponding to the fourth, fifth and sixth alternatives according to another embodiment of the present invention. Referring to FIG. 13, an FGS-MR inactivation unit 1310 prevents the FGS motion refinement technique from being applied to a key picture when a picture in a GOP of an input bit stream corresponds to the key picture. An AR-FGS inactivation unit 1320 blocks the AR-FGS technique from being applied to the key picture.

The fourth alternative corresponds to an SVC encoder including only the FGS-MR inactivation unit 1310, and the sixth alternative corresponds to an SVC encoder including the both the FGS-MR inactivation unit 1310 and the AR-FGS inactivation unit 1320. The fifth alternative corresponds to an SVC encoder that selectively uses the FGS-MR inactivation unit 1310 only when the AR-FGS technique is applied to a key picture.

As described above, the SVC encoders illustrated in FIGS. 11, 12, 13, and 14 can be selectively combined with one of the first to sixth alternatives.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An SVC encoder using improved AR-FGS and FGS motion refinement techniques, comprising:
a prediction signal determination unit determining a prediction signal of a current FGS layer block according to a scaling factor of a current FGS layer when interlayer prediction is not performed between a base quality layer or a lower FGS layer and the current FGS layer; and
a scaling factor determination unit determining a scaling factor used to predict a higher FGS layer block corresponding to the current FGS layer block based on a residual signal of the current FGS layer block.

2. The SVC encoder of claim 1, wherein the scaling factor is a usage rate of a previous block to predict the current FGS layer block.

3. The SVC encoder of claim 1, wherein the scaling factor of the current FGS layer is set to 0 and the prediction signal of the current FGS layer block is obtained in the same manner as the manner of obtaining a prediction signal of a base quality layer block.

4. The SVC encoder of claim 1, wherein the scaling factor of the current FGS layer is not 0.

5. The SVC encoder of claim 1, wherein interlayer prediction is performed between the current FGS layer block and the higher FGS layer block.

6. The SVC encoder of claim 1, wherein a reconstructed signal of the current FGS layer block includes the prediction signal and a residual signal.

7. An SVC encoder using improved AR-FGS and FGS motion refinement techniques, comprising:
an interlayer prediction setting unit setting that interlayer prediction is inevitably performed between a base layer and each FGS layer; and
a scaling factor determination unit determining a scaling factor of a higher FGS layer based on a residual signal of the base layer.

8. The SVC encoder of claim 7, wherein the scaling factor is a usage rate of a previous block to predict a current FGS layer block.

9. An SVC encoder using improved AR-FGS and FGS motion refinement techniques, comprising an FGS-MR inactivation unit preventing the FGS motion refinement technique from being applied to a key picture when a picture in a GOP of an input bit stream corresponds to the key picture.

10. The SVC encoder of claim 9, wherein the FGS-MR inactivation unit allows the FGS motion refinement technique to be applied to the key picture only when the AR-FGS technique is not applied to the key picture.

11. The SVC encoder of claim 9, further comprising an AR-FGS inactivation unit preventing the AR-FGS technique from being applied to the key picture.

12. An SVC encoder using improved AR-FGS and FGS motion refinement techniques, comprising:
an interlayer prediction setting unit setting that interlayer prediction is performed between a base layer and each FGS layer; and
a scaling factor determination unit determining a scaling factor used to predict a higher FGS layer block corresponding to a current FGS layer block based on a residual signal of the current FGS layer block.

13. The SVC encoder of claim 12, further comprising an FGS-MR inactivation unit preventing the FGS motion refinement technique from being applied to a key picture when a picture in a GOP of an input bit stream corresponds to the key picture.

14. The SVC encoder of claim 13, wherein the FGS-MR inactivation unit allows the FGS motion refinement technique to be applied to the key picture only when the AR-FGS technique is not applied to the key picture.

15. An encoding method in an SVC encoder using improved AR-FGS and FGS motion refinement techniques, the encoding method comprising:
determining a prediction signal of a current FGS layer block according to a scaling factor of a current FGS layer when interlayer prediction is not performed between a base quality layer or a lower FGS layer and the current FGS layer; and
determining a scaling factor used to predict a higher FGS layer block corresponding to the current FGS layer block based on a residual signal of the current FGS layer block.

16. The encoding method of claim 15, wherein the scaling factor is a usage rate of a previous block to predict the current FGS layer block.

17. The encoding method of claim 15, wherein the scaling factor of the current FGS layer is set to 0 and the prediction signal of the current FGS layer block is obtained in the same manner as the manner of obtaining a prediction signal of a base layer block.

18. The encoding method of claim 15, wherein the scaling factor of the current FGS layer is not 0.

19. The encoding method of claim 15, wherein interlayer prediction is performed between the current FGS layer block and the higher FGS layer block.

20. The encoding method of claim 15, wherein a reconstructed signal of the current FGS layer block includes the prediction signal and a residual signal.

21. An encoding method in an SVC encoder using improved AR-FGS and FGS motion refinement techniques, the encoding method comprising:
setting interlayer prediction to be inevitably performed between a base layer and each FGS layer; and
determining a scaling factor of a higher FGS layer based on a residual signal of the base layer.

22. The encoding method of claim 21, wherein the scaling factor is a usage rate of a previous block to predict a current FGS layer block.

23. An encoding method in an SVC encoder using improved AR-FGS and FGS motion refinement techniques, comprising preventing the FGS motion refinement technique from being applied to a key picture when a picture in a GOP of an input bit stream corresponds to the key picture.

24. The encoding method of claim 23, wherein the FGS motion refinement technique is allowed to be applied to the key picture only when the AR-FGS technique is not applied to the key picture.

25. The encoding method of claim 23, further comprising preventing the AR-FGS technique from being applied to the key picture.

26. An encoding method in an SVC encoder using improved AR-FGS and FGS motion refinement techniques, the encoding method comprising:
setting interlayer prediction to be performed between a base layer and each FGS layer; and
determining a scaling factor used to predict a higher FGS layer block corresponding to a current FGS layer block based on a residual signal of the current FGS layer block.

27. The encoding method of claim 26, further comprising preventing the FGS motion refinement technique from being applied to a key picture when a picture in a GOP of an input bit stream corresponds to the key picture.

28. The encoding method of claim 27, wherein the FGS motion refinement technique is allowed to be applied to the key picture only when the AR-FGS technique is not applied to the key picture.

29. An SVC decoder using improved AR-FGS and FGS motion refinement techniques, wherein, in an operation of decoding each FGS layer, a prediction signal of a current FGS layer block is decoded according to a scaling factor of a current FGS layer when the FGS motion refinement technique is applied to the current FGS layer and interlayer prediction is not performed between the current FGS layer and a base quality layer or a lower FGS layer, and the scaling factor is determined by an SVC encoder based on a residual signal of the current FGS layer block.

30. The SVC decoder of claim 29, wherein the scaling factor of the current FGS layer is set to 0.

31. An SVC decoder using improved AR-FGS and FGS motion refinement techniques, the SVC decoder necessarily determining a scaling factor of a higher FGS layer based on a residual signal of a base layer when a received bit stream is configured such that interlayer prediction must be performed between the base layer and each FGS layer to decode the received bit stream.

32. An SVC decoder using an improved AR-FGS technique, the SVC decoder determining a scaling factor used to predict a higher FGS layer block corresponding to a current FGS layer block based on a residual signal of a current FGS layer block when receiving a bit stream including an interlayer prediction setting signal that represents that interlayer prediction is set to be performed between a base layer and each FGS layer.

33. An SVC decoding method using improved AR-FGS and FGS motion refinement techniques, the SVC decoding method comprising:
determining whether a current frame corresponds to a key picture; and
determining whether the AR-FGS technique is applied when the current frame corresponds to the key picture and determining whether the FGS motion refinement technique is applied when the current frame does not correspond to the key picture.

34. The SVC decoding method of claim 33, further comprising determining whether the FGS motion refinement technique is applied when the current frame corresponds to the key picture and the AR-FGS technique is not applied.
